(19) United States
(12) Patent Application Publication
(10) Pub. No.: US 2026/0336336 A1
(43) Pub. Date: Oct. 29, 2026

(54) GOOSENECK BALL

(71) Applicant: Long Ouyang, Huanggang (CN)

(72) Inventor: Long Ouyang, Huanggang (CN)

(21) Appl. No.: 19/728,224

(22) Filed: Jul. 1, 2026

Related U.S. Application Data
(62) Division of application No. 19/274,818, filed on Jul. 21, 2025.

(51) Int. Cl. B60D 1/06; B60D 1/52

(52) U.S. Cl. CPC B60D 1/06; B60D 1/52

(57) ABSTRACT

A novel gooseneck ball is provided, which includes a spherical part configured to connect with a trailer ball cover; an installation part fixedly connected to the spherical part and configured to connect with an installation base; and a reinforcement part, located between the spherical part and the installation part and including at least one reinforcement rib, the reinforcement rib is fixedly provided on the spherical part and is extended to the installation part, or the reinforcement rib is fixedly provided on the installation part and is extended to the spherical part. This application has the effect of improving the load-bearing capacity of the gooseneck ball.

### CROSS-REFERENCE TO RELATED APPLICATIONS

This application is a divisional application of U.S. Patent Application No. Ser. No. 19/274,818, filed on Jul. 21, 2025, which is hereby incorporated by reference in its entirety.

### TECHNICAL FIELD

The present disclosure relates to the field of gooseneck ball technologies, and in particular, to a new type of gooseneck ball.

### BACKGROUND

At present, more and more users in the domestic market are beginning to use and engage in outdoor sports, including RVs, trailers, yachts, and other products. These large products require trailer connections with cars during use to enable RVs, trailers, yachts, and other vehicles to travel.

Referring to the diagram, generally speaking, the gooseneck ball includes a spherical part and an installation part. By installing the gooseneck ball on a mounting seat at a rear of the car, the installation part is fixedly connected to the mounting seat at the rear of the car. The front of the RV, trailer, and yacht is equipped with a trailer ball cover, which can press and fix the spherical part of the gooseneck ball inside the trailer ball cover to complete the trailer connection between the RV, trailer, yacht, and the car.

Regarding the above technical solution, the existing gooseneck ball has insufficient load-bearing capacity, resulting in the gooseneck ball being prone to breakage when used for towing.

### SUMMARY

In order to improve the load-bearing capacity of the gooseneck ball, this application provides a new type of gooseneck ball.

The new goose neck ball provided in this application adopts the following technical solution.

A goose neck ball, including:
a spherical part, the spherical part is configured to connect with a trailer ball cover;
an installation part, which is fixedly connected to the spherical part and configured to connect with an installation base; and
a reinforcement part, the reinforcement part is located between the spherical part and the installation part, the reinforcement part includes at least one reinforcement ribs, the reinforcement ribs are fixedly provided on the spherical part and are extended to the installation part, or the reinforcement ribs are fixedly provided on the installation part and are extended to the spherical part.

By adopting the above technical solution, when using the goose neck ball for towing, the installation part of the goose neck ball is fixedly connected to the installation base of the car or other trailer vehicle, and then the spherical part of the goose neck ball is fixedly connected to the trailer ball cover of the RV, yacht or other towed vehicle, so that the trailer vehicle can complete the towing of the towed vehicle. During towing, because the reinforcement part is provided between the spherical part and the installation part, and the reinforcement ribs are extended from the spherical part to the installation part, or from the installation part to the spherical part, a connection strength between the installation part and the spherical part is better, thereby making the bearing capacity of the goose neck ball better. Therefore, when using the goose neck ball for towing, the goose neck ball is not easy to use. Fracture occurred, which improved the insufficient load-bearing capacity of the existing gooseneck ball, resulting in difficulties when using it for towing, the gooseneck ball is prone to breakage.

In some embodiments of the present disclosure, the reinforcement part further includes a reinforcement top piece, and the reinforcement top piece is located between the spherical part and the reinforcement rib, the reinforcement top piece is connected to the spherical part or connected to the installation part; one side of the reinforcement top piece is fixedly connected to the reinforcement ribs.

In some embodiments of the present disclosure, the reinforcement part further includes a reinforcement bottom piece, the reinforcement bottom piece is located between the installation part and the reinforcement ribs, the reinforcement bottom piece is connected to the installation part, or the reinforcement bottom piece is connected to the spherical part; one side of the reinforcement bottom piece is connected to the reinforcement ribs.

In some embodiments of the present disclosure, the reinforcement part further includes one or more reinforcement pieces, and the reinforcement piece is connected to the spherical part or the installation part; the reinforcement piece is fixedly connected to the reinforcement ribs.

In some embodiments of the present disclosure, an axis of the spherical part does not coincide with an axis of the installation part.

In some embodiments of the present disclosure, the reinforcement ribs are arranged parallel to each other.

In some embodiments of the present disclosure, the reinforcement part further includes one or more reinforcement connection pieces, one end of each of the reinforcement connection pieces is fixedly connected to the spherical part, and the other end of each of the reinforcement connection pieces is fixedly connected to the installation part.

In some embodiments of the present disclosure, an axis of the spherical part coincides with an axis of the installation part.

In some embodiments of the present disclosure, the reinforcement ribs are uniformly distributed around the spherical part or around an axis of the installation part in a circumferential direction.

In summary, this application includes at least one beneficial technical effect as follows.

When using the gooseneck ball for towing, the installation part of the gooseneck ball are fixedly connected to the installation base of the car or other trailer vehicle, and then the spherical part of the gooseneck ball is fixedly connected to the trailer ball cover of the RV, yacht or other towed vehicle, so that the trailer vehicle can complete the towing of the towed vehicle. During towing, because the reinforcement part is provided between the spherical part and the installation part, and the reinforcement rib extends from the spherical part to the installation part, or from the installation part to the spherical part, the connection strength between the installation part and the spherical part is better, thereby improving the bearing capacity of the gooseneck ball. Therefore, when using the gooseneck ball for towing, the gooseneck ball is less likely to break, improving the existing situation. The insufficient load-bearing capacity of the gooseneck ball leads to the problem of breakage when using it for towing.

### BRIEF DESCRIPTION OF DRAWINGS

FIG. 1 is a schematic diagram of an overall structure of an embodiment.

FIG. 2 is a schematic diagram of an explosive structure in an embodiment.

FIG. 3 is a schematic structural diagram of a spherical part in an embodiment.

FIG. 4 is a schematic structural diagram of a main body segment in an embodiment.

FIG. 5 is a first schematic diagram of an overall structure of another embodiment.

FIG. 6 is a second schematic diagram of an overall structure of another embodiment

FIG. 7 is a third schematic diagram of an overall structure of another embodiment, FIG. 3.

FIG. 8 is a fourth schematic diagram of an overall structure of another embodiment 2, FIG. 4.

FIG. 9 is a first schematic diagram of an overall structure of a yet one embodiment.

FIG. 10 is a second schematic diagram of an overall structure of a yet one embodiment.

FIG. 11 is a first schematic diagram of an overall structure of a still one embodiment

FIG. 12 is a second schematic diagram of an overall structure of a still one embodiment.

FIG. 13 is a schematic structural diagram of a locking part of a still one embodiment.

Numeral reference: 1—spherical part; 11—spherical segment; 12—arc platform segment; 13—cylindrical segment; 2—installation part; 21—connection section; 22—main body section; 221—connection hole; 222—central hole; 23—first column section; 24—second column section; 241—locking hole; 25—third column section; 3—reinforcement part; 31—reinforcement rib; 32—reinforcement top piece; 33—reinforcement connection piece; 34—reinforcement bottom piece; 341—weight reduction slot; 35—reinforcement piece; 4—locking part; 41—locking rod; 411—locking segment; 412—rod body section; 413—clamp joint section; 414—cylindrical segment; 415—bottom section; 42—locking ball; 43—locking spring.

### DESCRIPTION OF EMBODIMENTS

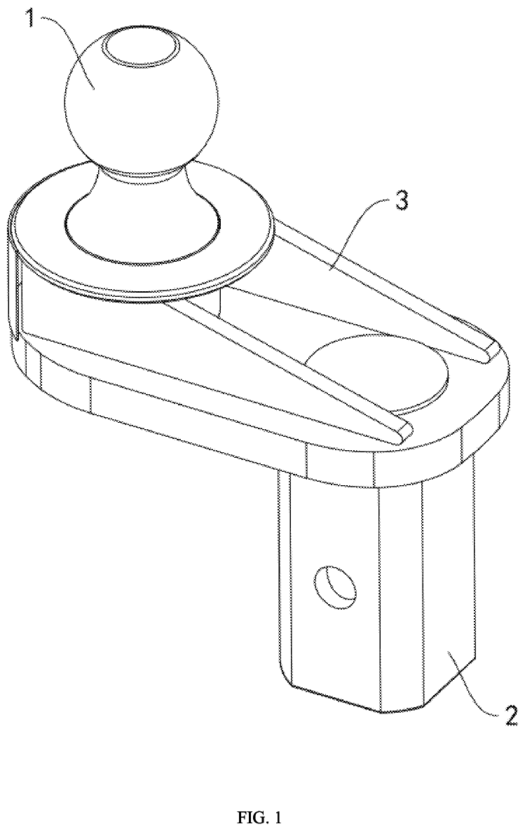

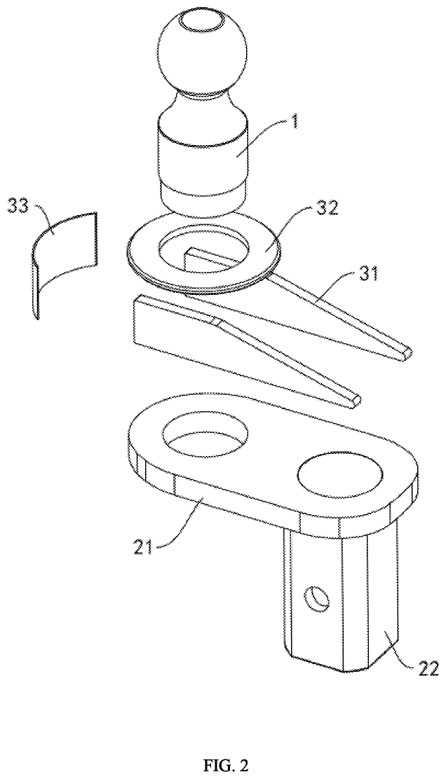

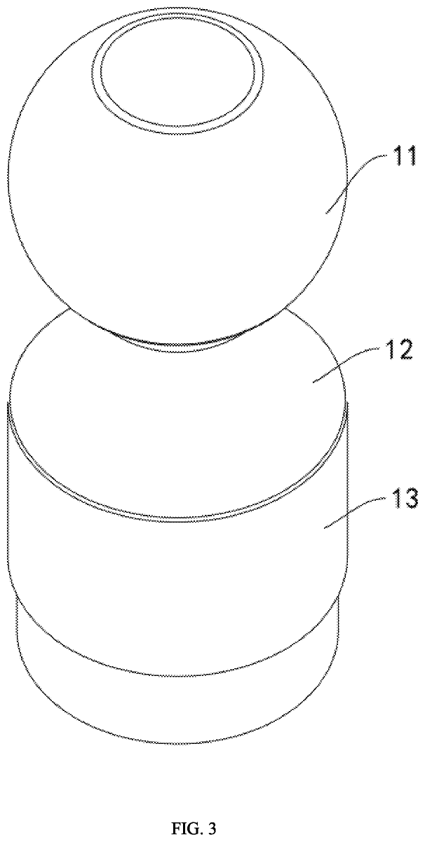

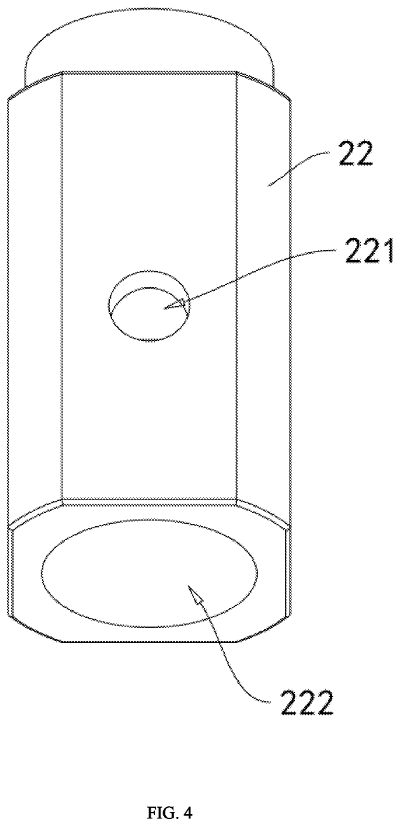

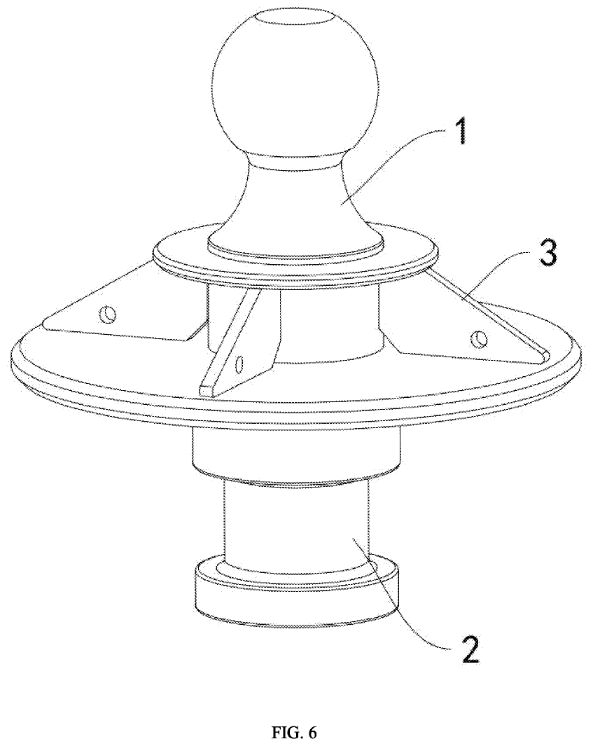

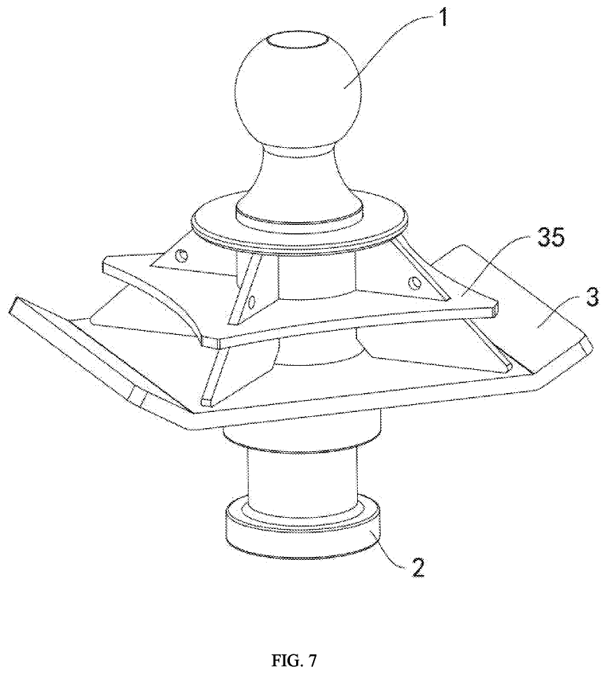

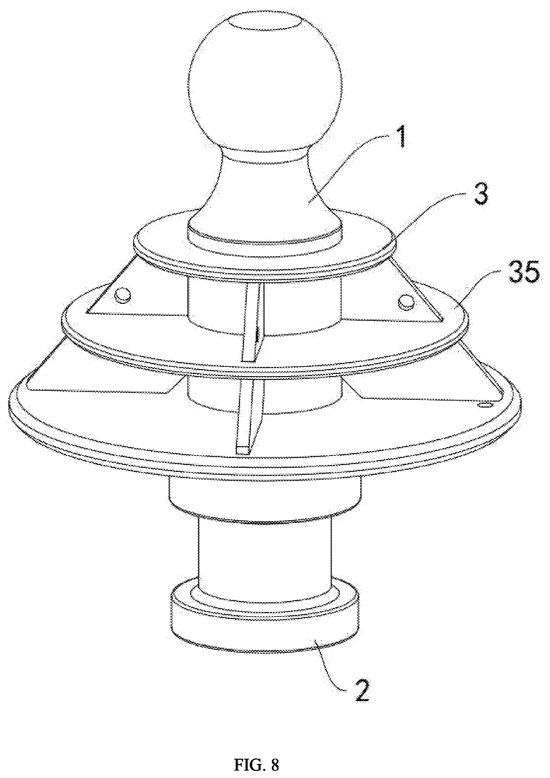

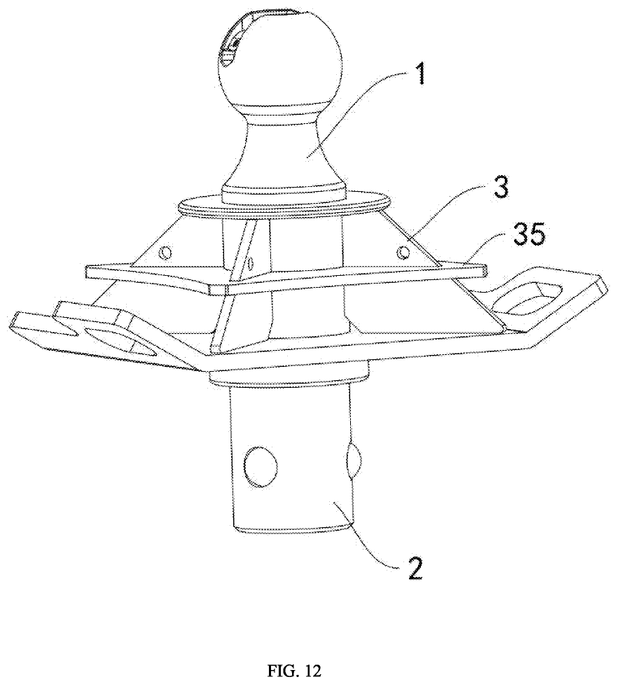

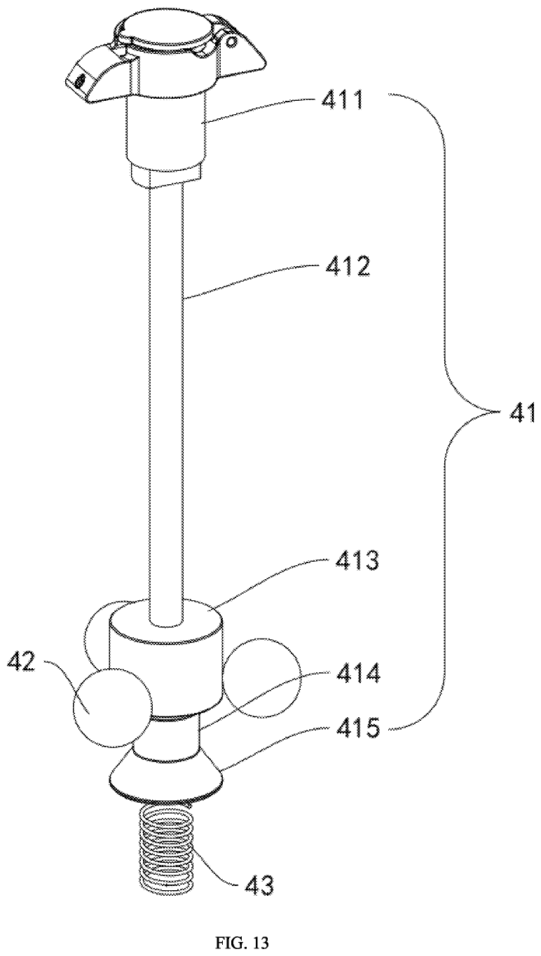

Further detailed explanation of the present application will be provided in combination with FIGS. 1-13.

This application discloses a novel gooseneck ball.

Referring to FIGS. 1 to 4, the gooseneck ball includes a spherical part 1, an installation part 2, and a reinforcement part 3. The spherical part 1 is connected to the reinforcement part 3, and an axis of the spherical part 1 does not coincide with an axis of the reinforcement part 3.

Referring to FIGS. 1 to 4, the spherical part 1 includes a spherical segment 11, an arc platform segment 12, and a cylindrical segment 13. The spherical segment 11, the arc platform segment 12, and the cylindrical segment 13 are fixedly connected in sequence. The spherical segment 11 is spherical in shape, and the arc platform segment 12 is gradually decreased in diameter from one end near the cylindrical segment 13 to the other end near the spherical segment 11. The cylindrical segment 13 is cylindrical in shape.

Referring to FIGS. 1 to 4, the installation part 2 includes a connection section 21 and a main body section 22. The connection section 21 is fixedly connected to the cylindrical segment 13, and the main body section 22 is fixedly connected to the connection section 21. The main body section 22 is rectangular in shape, and a central hole 222 is provided in a middle of the main body section 22. There are connection holes 221 that run through two sides of the main body section 22, and the two connection holes 221 are connected to the central hole 222.

Referring to FIGS. 1 to 4, the reinforcement part 3 includes two reinforcement ribs 31, a reinforcement top piece 32, and a reinforcement connection piece 33. The two reinforcement pieces 35 are fixedly arranged on an outer circumference of the cylindrical segment 13 and are extended along the connection section 21. The two reinforcement ribs 31 are arranged parallel to each other, and the reinforcement top piece 32 is located at a top of the two reinforcement ribs 31. The reinforcement top piece 32 is fixedly arranged on an outer circumference of the cylindrical segment 13; one side of the reinforcement top piece 32 is fixedly connected to the two reinforcement ribs 31. One end of the reinforcement connection piece 33 is fixedly connected to the spherical part 1, and the other end of the reinforcement connection piece 33 is fixedly connected to the installation part 2.

The implementation principle of this embodiment is: when using a gooseneck ball for towing, the installation part 2 of the gooseneck ball is fixedly connected to the installation base of the car or other trailer vehicle, and then the spherical part 1 of the gooseneck ball is fixedly connected to the trailer ball cover of the RV, yacht or other towed vehicle, so that the trailer vehicle completes the dragging of the towed vehicle. During the dragging, because the reinforcement part 3 is provided between the spherical part 1 and the installation part 2, and the reinforcement rib 31 is extended from the spherical part 1 to the installation part 2, a connection strength between the installation part 2 and the spherical part 1 is better, thereby rendering the bearing capacity of the gooseneck ball better. Therefore, when using the gooseneck ball for towing, the gooseneck ball is less prone to breakage, improving the insufficient load-bearing capacity of existing gooseneck balls, which leads to the problem of gooseneck balls easily breaking when used for towing.

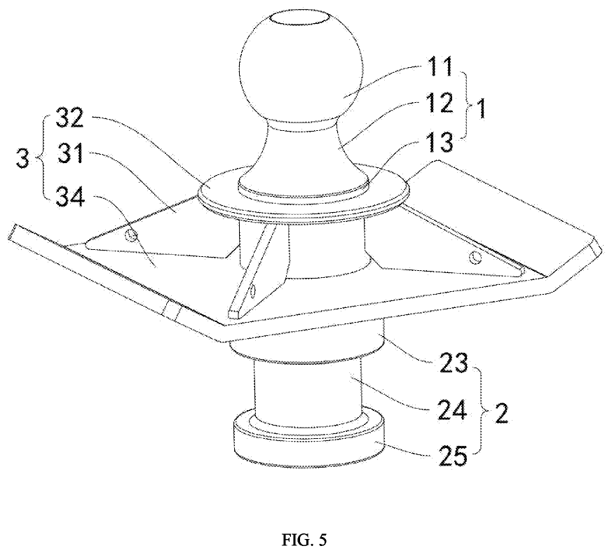

Referring to FIGS. 5 to 8, a novel gooseneck ball includes a spherical part 1, an installation part 2, and a reinforcement part 3. The spherical part 1 is connected to the reinforcement part 3, and an axis of the spherical part 1 coincides with an axis of the reinforcement part 3.

Referring to FIGS. 5 to 8, the spherical part 1 includes a spherical segment 11, an arc platform segment 12, and a cylindrical segment 13. The spherical segment 11, the arc platform segment 12, and the cylindrical segment 13 are fixedly connected in sequence. The spherical segment 11 is spherical in shape, and the arc platform segment 12 is gradually decreased in diameter from one end near the cylindrical segment 13 to the other end near the spherical segment 11. The cylindrical segment 13 is cylindrical in shape.

Referring to FIGS. 5 to 8, the installation part 2 includes a first column section 23, a second column section 24, and a third column section 25. The first column section 23 is fixedly connected to one end of the cylindrical segment 13 away from the arc platform section 12, and the first column section 23, the second column section 24, and the third column section 25 are fixedly connected from one end close to the cylindrical segment 13 towards one end away from the cylindrical segment 13. The first column section 23, the second column section 24, and the third column section 25 are all cylindrical in shape. A diameter of the first column section 23 is equal to a diameter of the third column section 25, and a diameter of the second column section 24 is smaller than a diameter of the first column section 23.

Referring to FIGS. 5 to 8, the reinforcement part 3 includes four reinforcement ribs 31, a reinforcement top piece 32, and a reinforcement bottom piece 34. Each of the reinforcement ribs 31 is fixedly provided on an outer circumferential surface of the cylindrical segment 13 and is extended along the first column section 23. The reinforcement top piece 32 is located at a top of each of the reinforcement ribs 31, and the reinforcement top piece 32 is fixedly provided on an outer circumferential surface of the cylindrical segment 13. One side of the reinforcement top piece 32 is fixedly connected to each of the reinforcement ribs 31, and the reinforcement bottom piece 34 is located at a bottom of each of the reinforcement ribs 31. The reinforcement bottom piece 34 is fixedly provided on an outer circumferential surface of the cylindrical segment 13 and is fixedly connected to one end of the first column section 23 near the cylindrical segment 13. The reinforcement bottom piece 34 is fixed to the reinforcement rib 31 on one side away from the first column section 23.

Referring to FIGS. 5 to 8, the reinforcement part 3 can further include a reinforcement piece 35, and the reinforcement piece 35 is located between the reinforcement top piece 32 and the reinforcement bottom piece 34. The reinforcement piece 35 is fixedly arranged on an outer circumferential surface of the cylindrical segment 13, and is fixedly connected to each of the reinforcement ribs 31.

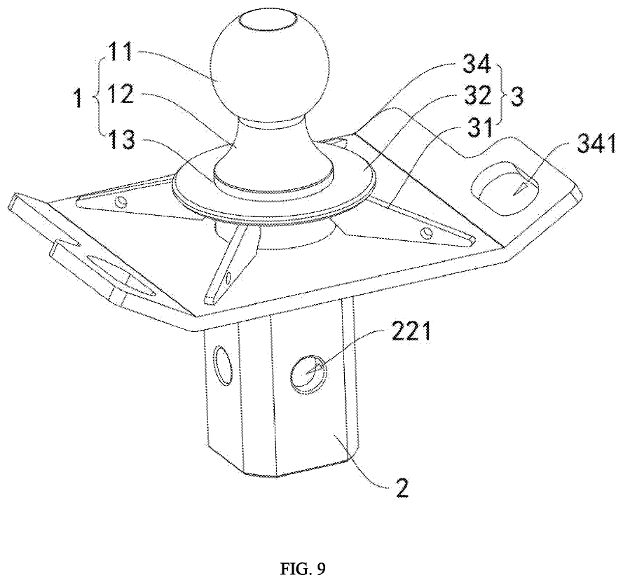

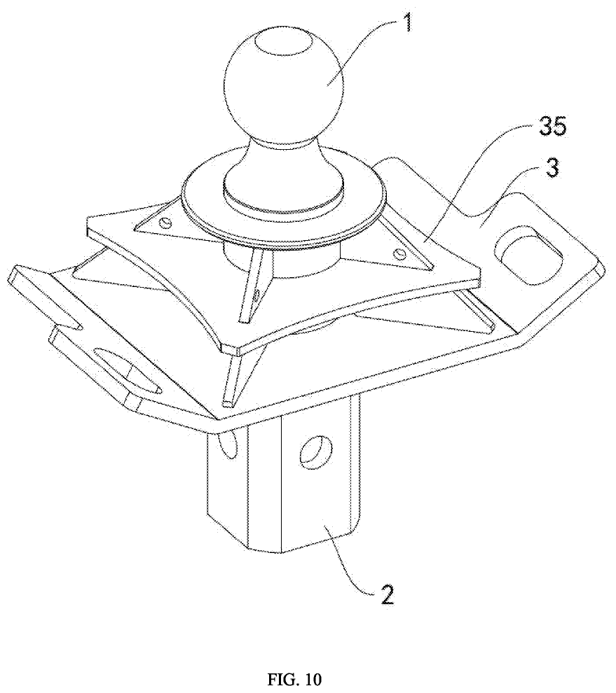

Referring to FIGS. 9 and 10, a novel gooseneck ball includes a spherical part 1, an installation part 2, and a reinforcement part 3. The spherical part 1 is connected to the reinforcement part 3, and an axis of the spherical part 1 coincides with an axis of the reinforcement part 3.

Referring to FIGS. 9 and 10, the spherical part 1 includes a spherical segment 11, an arc platform segment 12, and a cylindrical segment 13. The spherical segment 11, the arc platform segment 12, and the cylindrical segment 13 are fixedly connected in sequence. The spherical segment 11 is spherical in shape, and the arc platform segment 12 is gradually decreased in diameter from one end near the cylindrical segment 13 to the other end near the spherical segment 11. The cylindrical segment 13 is cylindrical in shape.

Referring to FIGS. 9 and 10, one end of the installation part 2 is fixedly connected to the cylindrical segment 13. The installation part 2 is rectangular in shape, and a central hole 222 is provided in a middle of the installation part 2. Two sides of the installation part 2 facing each other are provided with connection holes 221 that are penetrated, and each of the connection holes 221 is connected to the central hole 222.

Referring to FIGS. 9 and 10, the reinforcement part 3 includes four reinforcement ribs 31, a reinforcement top piece 32, and a reinforcement bottom piece 34. Each of the reinforcement ribs 31 is fixedly provided on an outer circumferential surface of the cylindrical segment 13 and is extended along an outer circumferential surface of the cylindrical segment 13 along the installation part 2. The reinforcement top piece 32 is located at a top of each of the reinforcement ribs 31, and the reinforcement top piece 32 is fixedly provided on an outer circumferential surface of the cylindrical segment 13. One side of the reinforcement top piece 32 is fixedly connected to each of the reinforcement ribs 31, and the reinforcement bottom piece 34 is located at a bottom of each of the reinforcement ribs 31. The reinforcement bottom piece 34 is fixedly provided on an outer circumferential surface of the cylindrical segment 13 and is fixedly connected to one end of the installation part 2 near the cylindrical segment 13. The reinforcement bottom piece 34 is fixedly connected to the reinforcement ribs 31 on one side away from the installation part 2. There are two weight reduction slots 341 that are penetrated.

Referring to FIGS. 9 and 10, the reinforcement part 3 can further include a reinforcement piece 35, and the reinforcement piece 35 is located between the reinforcement top piece 32 and the reinforcement bottom piece 34. The reinforcement piece 35 is fixedly arranged on an outer circumferential surface of the cylindrical segment 13, and is fixedly connected to each of the reinforcement ribs 31.

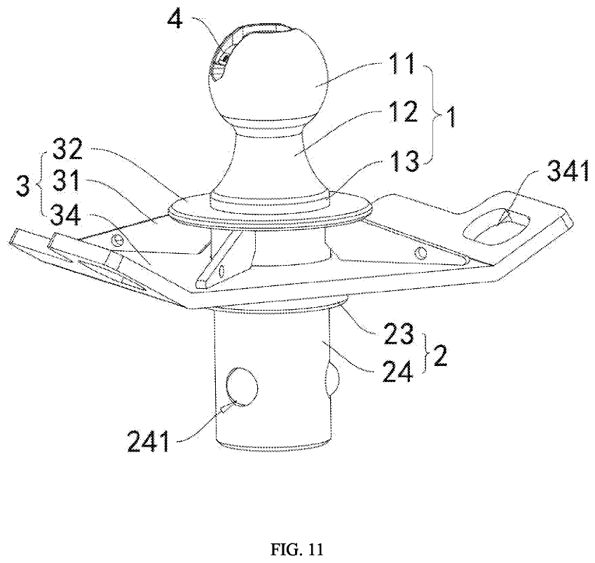

Referring to FIGS. 11 to 13, a novel gooseneck ball includes a spherical part 1, an installation part 2, a locking part 4, and a reinforcement part 3. The spherical part 1 is connected to the reinforcement part 3, and an axis of the spherical part 1 does not coincide with an axis of the reinforcement part 3.

Referring to FIGS. 11 to 13, the spherical part 1 includes a spherical segment 11, an arc platform segment 12, and a cylindrical segment 13. The spherical segment 11, the arc platform segment 12, and the cylindrical segment 13 are fixedly connected in sequence. The spherical segment 11 is spherical in shape, and the arc platform segment 12 is gradually decreased in diameter from one end near the cylindrical segment 13 to the other end near the spherical segment 11. The cylindrical segment 13 is cylindrical in shape.

Referring to FIGS. 11 to 13, the installation part 2 includes a first column section 23 and a second column section 24. The first column section 23 is fixedly connected to one end of the cylindrical segment 13 away from the arc platform segment 12, and the first column section 23 and the second column section 24 are fixedly connected from one end close to the cylindrical segment 13 towards one end away from the cylindrical segment 13. Both the first column section 23 and the second column section 24 are cylindrical in shape, and a diameter of the second column section 24 is smaller than that of the first column section 23.

Referring to FIGS. 11 to 13, the locking part 4 is positioned between the spherical part 1 and the installation part 2, and is in sliding fit with the installation part 2. The locking part 4 includes a locking rod 41, and the locking rod 41 includes a locking segment 411, a rod body section 412, a clamp joint section 413, a cylindrical segment 414, and a bottom section 415. The locking segment 411, the rod body section 412, the clamp joint section 413, the cylindrical segment 414, and the bottom section 415 are fixedly connected to each other from one end close to the spherical part 1 to one end close to the installation part 2. The locking part 4 further includes three locking balls 42 and a locking spring 43. An outer circumference of the second column section 24 is provided with three locking holes 241 that are penetrated and uniformly distributed on an axis of the second column section 24, each of the locking balls 42 is inserted and slid into each of the locking holes 241. One end of the locking spring 43 abuts against the second column section 24, and the other end of the locking spring 43 abuts against the bottom section 415.

Referring to FIGS. 11 to 13, when the installation part 2 is fixedly connected to the installation base, the locking rod 41 is slid in a direction close to the spherical part 1, the clamp joint section 413 is caused to slide on each of the locking balls 42 along each of the locking hole 241 in a direction away from an axis of the second column section 24, until the locking segment 411 is fixedly connected to the spherical part 1, thereby fixedly connecting each of the locking balls 42 to the installation base.

Referring to FIGS. 11 to 13, the reinforcement part 3 includes four reinforcement ribs 31, a reinforcement top piece 32, and a reinforcement bottom piece 34. Each of the reinforcement ribs 31 is fixedly provided on an outer circumferential surface of the cylindrical segment 13 and is extended along the first column section 23 along an outer circumferential surface of the cylindrical segment 13. The reinforcement top piece 32 is located at a top of each of the reinforcement ribs 31, and the reinforcement top piece 32 is fixedly provided on an outer circumferential surface of the cylindrical segment 13. One side of the reinforcement top piece 32 is fixedly connected to each of the reinforcement ribs 31, and the reinforcement bottom piece 34 is located at a bottom of each of the reinforcement ribs 31. The reinforcement bottom piece 34 is fixedly provided on an outer circumferential surface of the cylindrical segment 13 and is fixedly connected to one end of the first column section 23 near the cylindrical segment 13. The reinforcement bottom piece 34 is fixedly connected to the reinforcement ribs 31 on one side away from the first column section 23. The reinforcement bottom piece 34 is provided with two weight reduction slots 341 that are penetrated.

Referring to FIGS. 11 to 13, the reinforcement part 3 can further include a reinforcement piece 35, and the reinforcement piece 35 is located between the reinforcement top piece 32 and the reinforcement bottom piece 34. The reinforcement piece 35 is fixedly provided on an outer circumferential surface of the cylindrical segment 13, and is fixedly connected to each of the reinforcement ribs 31.

The above are preferred embodiments of the present application and do not limit the protection scope of the present application. Therefore, any equivalent changes made according to the structure, shape, and principle of the present application should be included in the protection scope of the present application.

What is claimed is:

1. A goose neck ball, comprising:
a spherical part, the spherical part is configured to connect with a trailer ball cover;
an installation part, which is fixedly connected to the spherical part and configured to connect with an installation base; and
a reinforcement part, the reinforcement part is located between the spherical part and the installation part, the reinforcement part comprises at least one reinforcement ribs, the reinforcement ribs are fixedly provided on the spherical part and are extended to the installation part, or the reinforcement ribs are fixedly provided on the installation part and are extended to the spherical part.

2. The goose neck ball according to claim 1, wherein the reinforcement part further comprises a reinforcement top piece, and the reinforcement top piece is located between the spherical part and the reinforcement rib,
the reinforcement top piece is connected to the spherical part or connected to the installation part;
one side of the reinforcement top piece is fixedly connected to the reinforcement ribs.

3. The goose neck ball according to claim 1, wherein the reinforcement part further comprises a reinforcement bottom piece,
the reinforcement bottom piece is located between the installation part and the reinforcement ribs,
the reinforcement bottom piece is connected to the installation part, or the reinforcement bottom piece is connected to the spherical part;
one side of the reinforcement bottom piece is connected to the reinforcement ribs.

4. The goose neck ball according to claim 1, wherein the reinforcement part further comprises one or more reinforcement pieces, and the reinforcement pieces are connected to the spherical part or the installation part;
the reinforcement pieces are fixedly connected to the reinforcement ribs.

5. The goose neck ball according to claim 1, wherein an axis of the spherical part coincides with an axis of the installation part.

6. The goose neck ball according to claim 5, wherein the reinforcement ribs are uniformly distributed around the spherical part or around an axis of the installation part in a circumferential direction.
